(19) United States
(12) Patent Application Publication
(10) Pub. No.: US 2024/0017329 A1
(43) Pub. Date: Jan. 18, 2024

(54) CUTTING INSERT FOR RECESS MACHINING, CUTTING INSERT KIT HAVING TWO SUCH CUTTING INSERTS, CUTTING INSERT HOLDER FOR SUCH CUTTING INSERTS, AND METHOD FOR PRODUCING A RECESS

(71) Applicant: MAPAL FABRIK FÜR PRÄZISIONSWERKZEUGE DR. KRESS KG, (US)

(72) Inventors: Wolfgang BAUMANN, Unterschneidheim (Zipplingen) (DE); Tobias GRÄUPEL, Abtsgmünd (DE)

(73) Assignee: MAPAL FABRIK FÜR PRÄZISIONSWERKZEUGE DR. KRESS KG, Aalen (DE)

(21) Appl. No.: 18/037,134

(22) PCT Filed: Nov. 25, 2021
(86) PCT No.: PCT/EP2021/083054

§ 371 Date: May 16, 2023

(30) Foreign Application Priority Data
Nov. 26, 2020 (DE) 102020214901.1

(51) Int. Cl. B23B 27/14; B23B 29/24

(52) U.S. Cl. CPC B23B 27/145; B23B 29/24; B23B 2200/0447; B23B 2200/369; B23B 2210/022; B23B 2220/08; B23B 2220/126; B23B 2226/125; B23B 2228/24

(57) ABSTRACT

The invention relates to a cutting insert holder, having a central axis and at least one first receptacle for fastening a first cutting insert to the cutting insert holder, and having at least one second receptacle for fastening at least one second cutting insert to the cutting insert holder, wherein the first receptacle and the second receptacle are arranged offset from each other in the circumferential direction about the central axis, wherein the first receptacle and the second receptacle are configured and arranged in such a way that a first rake face associated with an active main cutting edge of a first cutting insert arranged in the first receptacle has a first orientation along the circumferential direction, wherein a second rake face associated with an active main cutting edge of a second cutting insert arranged in the second receptacle has a second orientation along the circumferential direction).

The invention relates to a cutting insert for recess machining, a cutting insert kit with two such cutting inserts, a cutting insert holder, in particular for such cutting inserts, and a method for producing a recess, in particular a groove.

In recess machining, in particular in the production of grooves, the problem of burr formation at the recess edges frequently arises. This problem is even more acute when machining hard, quenched and tempered or hardened materials. Particularly problematic is the grooving of toothed shafts, for example for the production of Seegering grooves, since the resulting burrs can mean that the toothed shaft can no longer be joined to a gear or a mating shaft in a torque-transmitting manner. The discontinuous cutting conditions resulting from the toothing are particularly problematic. In particular, conventional piercing tools in radial design exhibit insufficient stability under such cutting conditions and therefore tend to chatter, which exacerbates the problem presented here.

Burrs that arise have to be removed at great expense, for example by grinding, which entails considerable post-processing work. Thus, overall problems arise in particular with regard to a high scrap rate and/or a high production effort as well as high production costs in connection with recess machining, in particular with the production of such grooves.

The invention therefore is based on the problem of providing a cutting insert for recess machining, a cutting insert kit with two such cutting inserts, a cutting insert holder, in particular for such cutting inserts, and a method for producing a recess, in particular a groove, wherein the aforementioned disadvantages do not occur.

The problem is solved by providing the present technical teaching, in particular the teaching of the independent claims as well as the embodiments disclosed in the dependent claims and the description.

In particular, the problem is solved by providing a cutting insert for recess machining. The cutting insert comprises a base body, as well as a recess protrusion projecting radially from the base body, wherein the recess protrusion comprises a main cutting edge at a work end adverted from the base body. The recess protrusion comprises a deburring cutting edge at least on one side at a transition end facing the base body in the transition area to the base body. Advantageously, during the machining of a workpiece with the cutting insert, first the main cutting edge comes into engagement with the workpiece, wherein in the course of the production of a recess, in particular a groove, in particular when a desired recess or groove depth is reached, finally also the deburring cutting edge arranged at the foot of the recess protrusion comes into engagement with the workpiece. In this case, the recess is deburred at its edge in one and the same operation with its insertion into the workpiece. In this way, the problem of burr formation is solved simply, precisely and inexpensively, and the production effort associated with recess machining is significantly reduced, which not least reduces production costs.

The cutting insert is adapted in particular for carrying out a method for producing a recess, in particular a groove, according to the invention, or for carrying out a method according to one or more of the embodiments described below. The cutting insert is configured, in particular, by the deburring cutting edge arranged at the transition end in the transition area to the base body at the recess protrusion, to carry out such a method.

The main cutting edge is preferably configured integrally, in particular as a single piece of material, with the recess protrusion. However, it is alternatively also possible in a preferred configuration that the main cutting edge is formed from a different material than the recess protrusion and is attached to the recess protrusion, in particular connected to the recess protrusion, in particular joined.

The deburring cutting edge is preferably configured integrally, in particular as a single piece of material, with the recess protrusion. However, it is alternatively also possible in a preferred configuration that the deburring cutting edge is formed from a different material than the recess protrusion and is attached to the recess protrusion, in particular connected to the recess protrusion, in particular joined.

Preferably, the recess protrusion is configured integrally, in particular as a single piece of material, with the base body.

Preferably, the recess protrusion and the main cutting edge, preferably with the deburring cutting edge, are configured integrally, in particular as a single piece of material, with the base body.

In a preferred configuration, the cutting insert comprises a mounting bore on the base body for fastening the cutting insert to a cutting insert holder, in particular a cutting insert holder according to the invention or a cutting insert holder according to one or more of the embodiments described below. The mounting bore preferably extends through the base body and is adapted to be itself extended through by a fastening means, in particular a fastening screw. The cutting insert holder, in particular the cutting insert holder according to the invention or preferred according to the invention described below, preferably comprises, at least according to one embodiment, a counter fastening means, preferably a thread, into which the fastening means, in particular the fastening screw, can engage in order to fasten the cutting insert to the cutting insert holder.

According to a further development of the invention, it is provided that the recess protrusion comprises a deburring cutting edge on each side of its transition end. The term “on both sides” refers in particular to an extension of the main cutting edge and thus in particular to a width direction of the recess formed with the cutting insert, in particular a groove width of the formed groove. At the recess protrusion, therefore, a deburring cutting edge is associated in particular with each end of the main cutting edge. In this way, it is possible to deburr both recess edges of the resulting recess, in particular both groove edges, at the same time, wherein one of the deburring cutting edges is assigned to each recess edge. Advantageously, the production effort is thus particularly low, and the cutting insert can be used particularly efficiently.

According to a further development of the invention, it is provided that the recess protrusion and the main cutting edge are configured and arranged relative to the base body in such a way that cutting forces are introduced tangentially into the base body during recess machining of a workpiece. The cutting forces introduced into the main cutting edge are thus tangentially supported by the cutting insert, wherein the entire cross-section of the cutting insert is available to support the cutting forces. This results in a very high stability of the cutting insert during recess machining, which in turn leads to a high quality of the resulting recess with low burr formation at the same time. In particular, the cutting insert has a significantly reduced tendency to chatter compared with radial support.

Tangential support means in particular that the main cutting edge extends perpendicular to a main level of the base body, wherein the main level is in particular a level of greatest extension of the base body, in particular a level on which the mounting bore is perpendicular. Thus, the main cutting edge preferably extends parallel to the mounting bore. The cutting forces are thus introduced in particular tangentially to an imaginary circumferential line around an axial direction defined by the mounting bore. In particular, the main cutting edge preferably extends in the axial direction.

According to a further development of the invention, it is provided that the cutting insert comprises at least one material selected from a group consisting of hard metal and cubic crystalline boron nitride, in particular PcBN. In this way, the cutting insert is adapted in particular advantageously to machine also hard, in particular quenched and tempered or hardened materials. Preferably, the cutting insert is made of a material selected from the group consisting of hard metal and cubic crystalline boron nitride, in particular PcBN. According to a preferred configuration, it is possible for the cutting insert to be formed substantially from cemented carbide and comprising a layer or sheet of cubic crystalline boron nitride. However, it is alternatively preferred that the cutting insert is formed entirely of cemented carbide. According to another preferred configuration, it is possible that the cutting insert consists entirely of cubic crystalline boron nitride.

Alternatively or additionally, the cutting insert is preferably coated at least in the region of the main cutting edge, preferably at least in the region of the recess protrusion. In particular, the coating can advantageously contribute to the suitability of the cutting insert for machining hard, in particular quenched and tempered or hardened materials. A coating material with which the cutting insert is preferably coated is preferably selected from a group consisting of TiAlN, TiAlSiN, TiSiN, TiCN, TiN, AlCrN, and Al₂O₃.

Alternatively or additionally, the cutting insert is preferably coated at least in the deburring cutting edge area.

According to a preferred configuration, the cutting insert is coated only in the region of the main cutting edge, or only in the region of the deburring cutting edge, or on the one hand in the region of the main cutting edge and on the other hand in the region of the deburring cutting edge, or only in the region of the recess protrusion. Alternatively, however, it is also possible in a preferred configuration for the cutting insert to be coated as a whole.

According to a further development of the invention, it is provided that at least one cutting edge stabilization geometry is associated with the main cutting edge. By means of the cutting edge stabilization geometry, the stability and thus the machining quality, but also a tool life of the cutting insert, can be advantageously increased. In particular, the main cutting edge is protected by the cutting edge stabilization geometry, which is especially advantageous when machining hard, in particular quenched and tempered or hardened materials. In particular, the cutting edge stabilization geometry results in the cutting insert having to be changed less frequently, so that production costs are low.

Preferably, the cutting insert comprises the cutting edge stabilization geometry. Alternatively or additionally, the cutting edge stabilization geometry is preferably arranged in a transition area from the main cutting edge to a flank face. In particular, the transition from the main cutting edge to the flank face is less abrupt due to the cutting edge stabilization geometry, so that the main cutting edge is less sensitive.

The at least one cutting edge stabilization geometry is preferably selected from a group consisting of a rounding and a chamfer. These geometries have proven to be particularly suitable for stabilizing the main cutting edge. It is possible that the cutting edge stabilization geometry comprises only a rounding or only a chamfer. However, it is also possible that the cutting edge stabilization geometry comprises a combination of a rounding and a chamfer—in particular arranged one behind the other starting from the main cutting edge. The cutting edge stabilization geometry can also comprise a plurality of roundings, chamfers, or roundings and chamfers.

According to a further development of the invention, it is provided that the cutting insert is configured as an indexable cutting insert, wherein the cutting insert comprises at least two grooving projections arranged offset from one another in a circumferential direction of the base body—in particular diametrically opposite one another. This necessitates a particularly economical configuration of the cutting insert, since it can first be rotated when a first recess protrusion of the recess protrusions is worn, so that a second recess protrusion of the recess protrusions is used for further workpiece machining, wherein the cutting insert does not have to be replaced until all recess protrusions are worn. Thus, in particular, the cutting insert does not already have to be replaced when a first and possibly only recess protrusion is worn.

The problem is also solved by providing a cutting insert kit comprising a first cutting insert according to the invention or a first cutting insert according to one or more of the previously described embodiments. The cutting insert kit further comprising a second cutting insert according to the invention, or a second cutting insert according to one or more of the previously described embodiments. The recess protrusion of the first cutting insert comprises a first working width. The recess protrusion of the second cutting insert comprises a second working width. The second working width is greater than the first working width. In connection with the cutting insert kit, the advantages already explained in connection with the cutting insert arise in particular.

The cutting insert kit is in particular adapted for carrying out a method for producing a recess, in particular a groove, according to the invention, or for carrying out a method according to one or more of the embodiments described below. The cutting insert kit is configured in particular by the first cutting insert and the second cutting insert, each comprising a deburring cutting edge arranged at the respective transition end in the transition area to the base body at the recess protrusion, for carrying out such a method.

By a cutting insert kit is meant in particular an assembly of cutting inserts, in particular a set of at least two cutting inserts.

A working width of a recess protrusion is understood to mean in particular an extension of the main cutting edge associated with the recess protrusion in the width direction of the recess to be formed or formed with the recess protrusion, in particular in the direction of a groove width being formed.

By the second working width being larger than the first working width, the first cutting insert is adapted for rough machining or pre-machining a workpiece, in particular a recess, in particular a groove, wherein the second cutting insert is adapted for finishing machining or finish machining the workpiece, in particular the recess, in particular the groove. Roughing machining or pre-machining is also briefly referred to as roughing, and finishing machining or finish machining is also briefly referred to as finishing. The difference between the first and second working widths is also referred to as machining allowance and defines an amount of material to be removed during finish machining relative to pre-machining Thus, the second recess protrusion comprises a machining allowance relative to the first recess protrusion.

With the cutting insert kit, it is possible in a simple, fast and cost-effective manner to carry out and complete a complete recess machining on a workpiece, in particular since preliminary and finishing operations can be carried out directly one after the other in an analogous manner with cutting inserts that are similar to one another—in particular identical except for the different working widths. This is particularly efficient if the first cutting insert and the second cutting insert of the cutting insert kit are arranged on the same cutting insert holder, in particular on the cutting insert holder according to the invention or a cutting insert holder according to one or more of the embodiments described below.

The problem is also solved by providing a cutting insert holder comprising a central axis and at least one first receptacle for attaching a first cutting insert to the cutting insert holder. The cutting insert holder comprises at least one second receptacle for attaching at least one second cutting insert to the cutting insert holder, wherein the first receptacle and the second receptacle are circumferentially offset from each other about the central axis. The first receptacle and the second receptacle are configured and arranged such that a first rake face of a first cutting insert disposed in the first receptacle associated with an active main cutting edge has a first orientation along the circumferential direction, wherein a second rake face of a second cutting insert disposed in the second receptacle associated with an active main cutting edge has a second orientation along the circumferential direction. The first orientation is opposite to the second orientation when the first cutting insert and the second cutting insert are attached to the cutting insert holder, in particular when the active main cutting edges are each arranged in an engagement position for machining a workpiece. In connection with the cutting insert holder, the advantages already explained in connection with the cutting insert and the cutting insert kit arise in particular.

By an active main cutting edge is meant, in particular, a main cutting edge that is arranged and aligned on the cutting insert holder in such a way that workpiece machining can be performed with the main cutting edge. In particular, when a cutting insert is configured as an indexable cutting insert, it comprises, in addition to an active main cutting edge, at least one passive main cutting edge in the sense that the passive main cutting edge is not arranged in a machining position or engagement position, but rather in a rest or waiting position.

The first cutting insert is also referred to as a roughing insert and is provided for pre-machining or roughing. The second cutting insert is also referred to as a finishing insert and is provided for finish machining or finishing.

The cutting insert holder is adapted in particular for carrying out a method for producing a recess, in particular a groove, according to the invention, or for carrying out a method according to one or more of the embodiments described below. The cutting insert holder is configured in particular for carrying out such a method, since the first cutting insert and the second cutting insert can be arranged in the corresponding first and second orientation on the cutting insert holder, so that a workpiece can be machined in the course of the method with reversal of the direction of rotation of a relative rotation between the workpiece and the cutting insert holder first—with a first direction of rotation—with the first cutting insert and then—with a second direction of rotation opposite to the first direction of rotation—with the second cutting insert.

In particular, due to the arrangement of the two recess projections of the cutting inserts in reverse orientation with respect to the circumferential direction and thus at the same time a reverse sense of rotation of a relative rotation between the workpiece and the cutting insert holder for the different cutting inserts, a particularly efficient, fast and thus also cost-effective recess machining of a workpiece is possible with deburring of a manufactured recess with the cutting insert holder.

An axial direction with respect to the cutting insert holder is in particular a direction that extends parallel to the central axis of the cutting insert holder or coincides with the central axis of the cutting insert holder. A radial direction is perpendicular to the axial direction, and a circumferential direction concentrically embraces the axial direction.

The two receptacles for the cutting inserts are preferably arranged on the cutting insert holder such that, when the cutting inserts are mounted on the cutting insert holder, an axial direction of the cutting inserts is aligned parallel to the axial direction of the cutting insert holder. In particular, the mounting bores of the cutting inserts preferably extend in the axial direction of the cutting insert holder. Thus, ultimately, the main cutting edge of each cutting insert also extends along the axial direction of the cutting insert holder, and the circumferential direction is locally perpendicular to the rake faces of the cutting inserts.

The receptacles for the first cutting insert and the second cutting insert are preferably arranged on the cutting insert holder in such a way that the grooving projections are aligned inwardly in the radial direction toward the central axis when the cutting inserts are arranged on the respective receptacles. In particular, the receptacles are arranged on an outer circumference of the cutting insert holder. In this way, it is in particular possible to arrange a workpiece in an inner machining region, in particular in the region of the central axis of the cutting insert holder, and to machine the workpiece first with the first cutting insert and then with the second cutting insert, in particular by first feeding the first cutting insert and then the second cutting insert in the radial direction towards the workpiece, by which in particular is meant a relative movement between the workpiece and the cutting inserts. This includes either the workpiece being displaced and the cutting insert holder being held at rest, or the cutting insert holder being displaced and the workpiece being held at rest, or the cutting insert holder and the workpiece both being displaced relative to each other.

In particular, it is preferred to have a configuration of the cutting insert holder wherein a first cutting insert, in particular a cutting insert according to the invention or a cutting insert according to one or more of the previously described embodiments, is arranged at the first receptacle, wherein a second cutting insert, in particular a cutting insert according to the invention or a cutting insert according to one of the previously described embodiments, is arranged at the second receptacle. Particularly preferred is a configuration of the cutting insert holder in which a cutting insert kit, in particular a cutting insert kit according to the invention or a cutting insert kit according to one or more of the previously described embodiments, is arranged on the cutting insert holder, in particular a first cutting insert of the cutting insert kit is arranged on the first receptacle, and a second cutting insert of the cutting insert kit is arranged on the second receptacle.

That a cutting insert is arranged at a receptacle includes that the cutting insert is arranged in the receptacle.

In a preferred configuration, it is possible for the cutting insert holder to comprise more than one first receptacle for a plurality of first cutting inserts. Alternatively or additionally, the cutting insert holder preferably comprises more than one second receptacle for a plurality of second cutting inserts.

It is also possible that at least one further receptacle for at least one further cutting insert is arranged on the cutting insert holder, wherein the at least one further receptacle and the at least one further cutting insert are provided for at least one intermediate machining step between the pre-machining and the finishing machining.

If the cutting insert holder comprises exactly one first receptacle and exactly one second receptacle, the two receptacles are preferably arranged diametrically opposite each other, in particular offset by 180° relative to each other in the circumferential direction on the cutting insert holder. If the cutting insert holder comprises a plurality of first receptacles and/or a plurality of second receptacles, smaller angular distances between adjacent receptacles are preferably obtained, for example 90° each for a total of four receptacles.

According to a further development of the invention, it is provided that the cutting insert holder is adapted to a workpiece to be machined in such a way that a first cutting insert arranged on the at least one first receptacle and a second cutting insert arranged on the at least one second receptacle can be advanced towards the workpiece separately from one another and, in particular, one after the other in time. In this way, sequential machining of the workpiece can advantageously be performed simply and quickly, first with the first cutting insert and then with the second cutting insert. In particular, a radius of a circumferential line of the cutting insert holder on which the receptacles are arranged is preferably selected such that the workpiece can be arranged in the region of the central axis within the circumference of the cutting insert holder such that first the first cutting insert can engage the workpiece while the second cutting insert is not engaged with the workpiece, wherein thereafter a relative radial feed of the cutting insert holder towards the workpiece can be performed such that the second cutting insert engages the workpiece while the first cutting insert is not engaged with the workpiece.

The cutting insert holder preferably comprises an interface for attaching the cutting insert holder to a machine tool. In particular, the interface may be configured in various ways. In particular, it is also possible for the interface on the cutting insert holder to be replaceable. The cutting insert holder can then preferably be used with different machine tools.

For example, the interface can be configured as a VDI40 receptacle, a steep taper interface, a Morse taper interface, an HSK interface, or in other suitable ways.

The cutting insert holder is preferably adapted to cooperate with a machine tool selected from a group consisting of a vertical lathe, a horizontal lathe, and a machining center.

Finally, the problem is also solved by providing a method for producing a recess, in particular a groove, in particular a ring groove, in particular a Seegering groove, in a workpiece, in particular a toothed shaft, in particular in a shaft with toothing, wherein the method comprises the following steps: The workpiece is pre-machined in that a preliminary recess, in particular a preliminary groove, is cut into the workpiece by means of a first cutting insert, in particular by means of a first cutting insert according to the invention or a first cutting insert according to one or more of the embodiments described above, wherein the preliminary recess comprises a first width. Thereby, a relative rotation of the workpiece to the first cutting insert is effected with a first direction of rotation. This machining step is also referred to as roughing. The workpiece is finish-machined by means of a second cutting insert, in particular by means of a second cutting insert according to the invention or a second cutting insert according to one or more of the previously described embodiments, wherein the preliminary recess extended to a second width, wherein the second width is larger than the first width. This causes relative rotation of the workpiece to the second cutting insert with a second direction of rotation. This machining step is also referred to as finishing. In this way, the recess, in particular the groove, is produced. The second direction of rotation is opposite to the first direction of rotation. The resulting recess is deburred during finishing, in particular by means of the second cutting insert. In connection with the method, there are in particular those advantages which have already been explained in connection with the cutting insert, the cutting insert kit and the cutting insert holder.

By changing the direction of rotation between roughing and finishing, in particular by changing the direction of relative rotation, the burr created can be removed particularly efficiently, resulting in a simultaneously high working speed and high machining quality. In particular, the burr created during roughing is removed during finishing in the opposite direction to the roughing machining direction, with a finishing machining direction opposite to the roughing machining direction.

Deburring of the recess, in particular the groove, is easily and precisely possible in particular with a cutting insert according to the invention or a cutting insert according to one or more of the embodiments described above, comprising the deburring cutting edge in the transition area to the base body at the foot or transition end of the recess protrusion.

The relative rotation between the workpiece and the cutting inserts can be effected by rotating the workpiece relative to the cutting inserts; however, it is also preferably possible that at least the currently active cutting insert, preferably both cutting inserts, are rotated relative to the workpiece; also, in a preferred configuration, it is possible—in particular in the case of machining on a machining center—that the relative rotation is effected by moving both the workpiece and the cutting inserts relative to each other in a suitable manner.

It is preferably possible that the pre-machining is carried out with a plurality of first cutting inserts. Alternatively or additionally, it is preferably possible that the finish machining is performed with a plurality of second cutting inserts. Alternatively or additionally, it is possible that at least one intermediate step between the pre-machining and the finish-machining is carried out with at least one further cutting insert. In particular, it is important that the direction of rotation of the relative rotation between the workpiece and the respective cutting insert coming into engagement with the workpiece is changed at the latest before a final finishing step, preferably before a first finishing step, or before the only finishing step, with respect to the direction of rotation in the immediately preceding working step.

According to a further embodiment of the invention, it is provided that the first relative rotation is effected between the workpiece and a tool comprising the first cutting insert and the second cutting insert, in particular a cutting insert holder according to the invention or a cutting insert holder according to one or more of the previously described embodiments. The second relative rotation is effected between the workpiece and the same tool, in particular the cutting insert holder, wherein during pre-machining the first cutting insert is engaged with the workpiece, and wherein during finish-machining the second cutting insert is engaged with the workpiece. This is possible with the cutting insert holder according to the invention or a cutting insert holder according to one or more of the embodiments described above, in particular due to the arrangement of the first cutting insert with the first orientation and the second cutting insert with the second orientation on the cutting insert holder.

According to a further embodiment of the invention, it is provided that for pre-machining the first cutting insert is fed towards the workpiece, wherein for finishing the second cutting insert is fed towards the workpiece. This includes all possibilities of relative movement between the workpiece and the cutting inserts, in particular that the cutting inserts are displaced while the workpiece is at rest, or that the workpiece is displaced while the cutting inserts are at rest, or that both the workpiece and the cutting inserts are displaced.

According to a further development of the invention, it is provided that a toothed shaft is machined as the workpiece. In this case, the advantages already described are realized in a special way, in particular due to the discontinuous, interrupted cutting conditions.

According to a further development of the invention, it is provided that the recess, in particular the groove, is made in the workpiece in the hardened or quenched and tempered condition of the workpiece. In this case, the advantages already described are realized in a special way. The workpiece preferably comprises a hardness of at least 36 HRC to at most 60 HRC. HRC is the Rockwell hardness on the C scale.

According to a further development of the invention, it is provided that the process is carried out on a vertical lathe, on a horizontal lathe or on a machining center. These machine tools have proven to be particularly suitable for the process. Preferably, when a vertical lathe is used and when a horizontal lathe is used, the relative rotation is effected by rotating the workpiece, wherein the cutting inserts are held at rest or merely fed—in particular radially—toward the workpiece. In a machining center, a complex relative movement is preferably performed by moving both the workpiece and the cutting inserts in a suitable manner to effect the relative rotation.

The invention is explained in more detail with reference to the drawing. Thereby show:

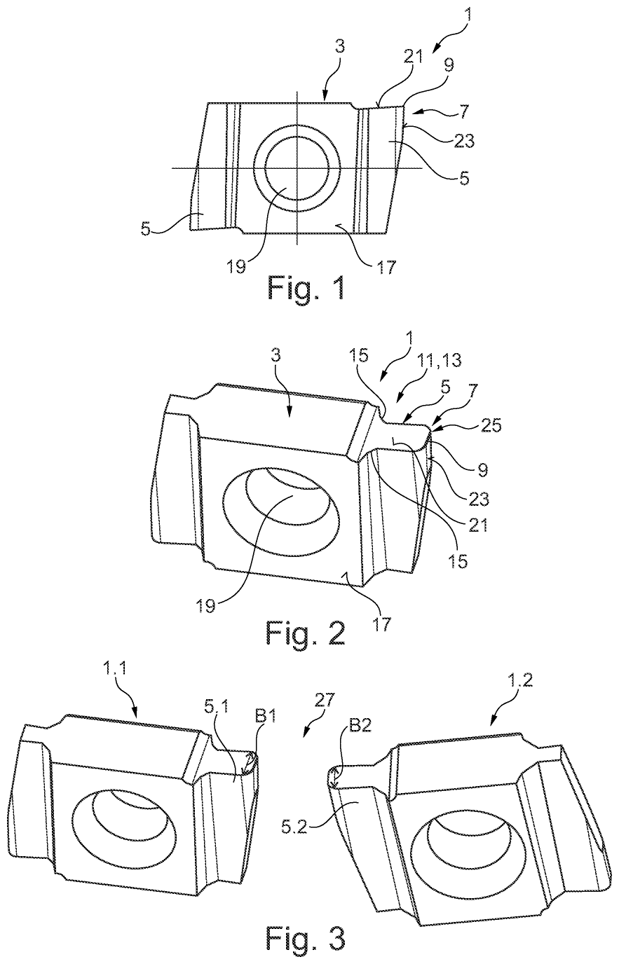

FIG. 1 a first representation of an embodiment of a cutting insert;

FIG. 2 a second representation of the cutting insert according to FIG. 1;

FIG. 3 a representation of an embodiment of a cutting insert kit;

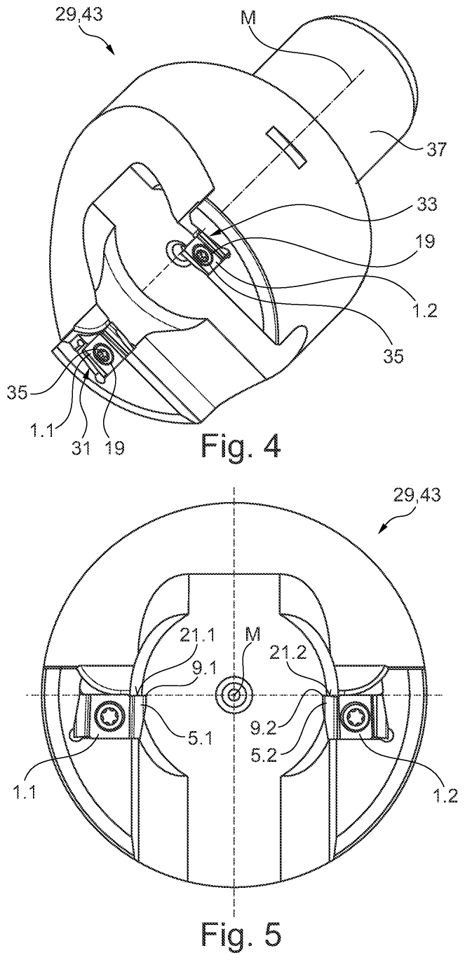

FIG. 4 a first representation of an embodiment of a cutting insert holder;

FIG. 5 a second representation of the cutting insert holder according to FIG. 4;

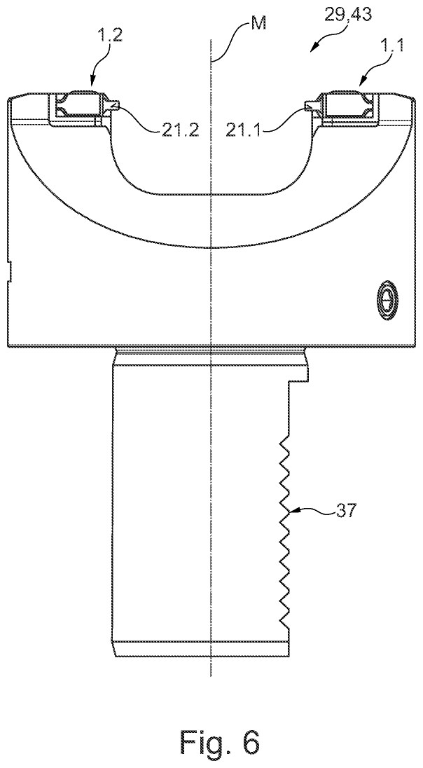

FIG. 6 a third representation of the cutting insert holder according to FIGS. 4 and 5;

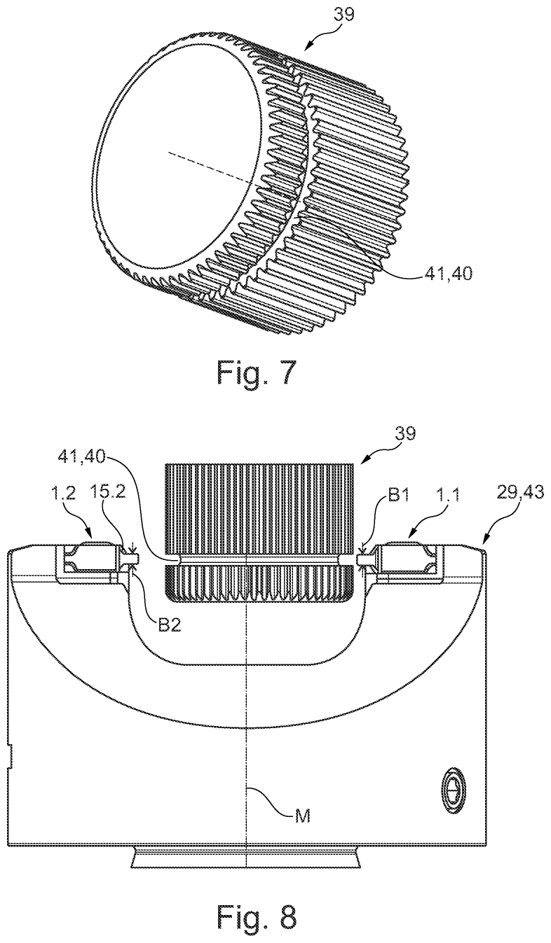

FIG. 7 a representation of a workpiece for machining with the cutting insert according to FIG. 1 and the cutting insert holder according to FIG. 4, and

FIG. 8 a schematic representation of an embodiment of a method for producing a recess, in particular a groove.

FIG. 1 shows a first representation of an embodiment of a cutting insert 1. The cutting insert 1 is adapted for recess machining and comprises a base body 3, as well as a recess protrusion 5 projecting radially from the base body 3. In the embodiment shown here, the cutting insert 1 is configured as an indexable cutting insert and comprises two recess protrusions 5 arranged offset from one another in the circumferential direction of the base body 3. The recess projections 5 are preferably configured identically, so that only one of the recess projections 5 will be discussed in more detail below.

The recess protrusion 5 comprises a main cutting edge 9 at a work end 7 facing away from the base body 3.

FIG. 2 shows a second representation of the cutting insert 1 according to FIG. 1.

Identical and functionally identical elements are provided with the same reference signs in all figures, so that reference is made in each case to the preceding description.

It is clear from the second representation that the recess protrusion 5 comprises a deburring cutting edge 15 at a transition end 11 facing the base body 3 in a transition area 13 to the base body 3 at least on one side—on both sides in the embodiment shown here. The transition end 11 is also referred to as the foot of the recess protrusion 5.

With the deburring cutting edge 15, it is advantageously possible to remove a burr formed on a workpiece during recess machining efficiently and with little effort.

In the embodiment shown here, the recess protrusion 5 and the main cutting edge 9 are configured integrally, in particular as a single piece of material, with the base body 3.

Also shown is a main level 17 of the base body 3, as well as a mounting bore 19 which passes through the base body 3 perpendicular to the main level 17 along an axial direction of the base body 3 and thus at the same time of the cutting insert 1.

The recess protrusion 5 and the main cutting edge 9 are preferably configured and arranged relative to the base body 3 in such a way that cutting forces are introduced tangentially into the base body 3 during recess machining of a workpiece. In particular, the main cutting edge 9 extends perpendicular to the main level 17, in particular in the axial direction, in particular parallel to the mounting bore 19.

The cutting insert 1 preferably comprises at least one material selected from a group consisting of cemented carbide and cubic crystalline boron nitride. Alternatively or additionally, the cutting insert 1 is coated at least in the region of the recess protrusion 5.

In the region of the main cutting edge 9, in particular, a rake face 21 adjoins a flank face 23 of the cutting insert 1. Preferably, the main cutting edge 9 forms a line of intersection between the rake face 21 and the flank face 23.

Preferably, a cutting edge stabilization geometry 25 is associated with the main cutting edge 9. The cutting edge stabilization geometry 25 is preferably selected from a group consisting of a rounding and a chamfer.

FIG. 3 shows a representation of an embodiment of a cutting insert kit 27. The cutting insert kit 27 comprises a first cutting insert 1.1 and a second cutting insert 1.2. In this regard, the two cutting inserts 1.1, 1.2 are each preferably configured according to the embodiment previously explained in connection with FIGS. 1 and 2. However, a first recess protrusion 5.1 of the first cutting insert 1.1 has a first working width B1 that is smaller than a second working width B2 of a second recess protrusion 5.2 of the second cutting insert 1.2. In this way, the first cutting insert 1.1 is preferably configured for roughing or pre-machining, while the second cutting insert 1.2 is configured for finishing or finish machining.

FIG. 4 shows a first representation of an embodiment of a cutting insert holder 29. The cutting insert holder 29 comprises a central axis M and a first receptacle 31 for fastening a first cutting insert 1.1, in particular the first cutting insert 1.1 of the cutting insert kit 27 according to FIG. 3, to the cutting insert holder 29. Furthermore, the cutting insert holder 29 comprises a second receptacle 33 for fastening a second cutting insert 1.2, in particular the second cutting insert 1.2 of the cutting insert kit 27 according to FIG. 3, to the cutting insert holder 29. The central axis M defines an axial direction of the cutting insert holder 29. In particular, the cutting inserts 1.1, 1.2 are held in their respective receptacles 31, 33 in such a way that their respective axial directions, in particular the mounting bores 19, are aligned parallel to the axial direction, i.e. to the central axis M, of the cutting insert holder 29.

It is also represented that the cutting inserts 1.1, 12 are preferably fastened to the cutting insert holder 29 by means of fastening means 35 configured as fastening screws.

The first receptacle 31 and the second receptacle 33 are arranged offset from one another in the circumferential direction about the central axis M, in particular diametrically opposite one another.

The cutting insert holder 29 comprises an interface 37 adapted to connect the cutting insert holder 29 to a machine tool.

FIG. 5 shows a second representation of the cutting insert holder 29 according to FIG. 4. On the basis of this representation, it is clear that the first receptacle 31 and the second receptacle 33 are configured and arranged in such a way that a first rake face 21.1, assigned to an active main cutting edge 9.1, of the first cutting insert 1.1 arranged in the first receptacle 31 has a first orientation along the circumferential direction, wherein a second rake face 21.2, assigned to an active main cutting edge 9.2, of the second cutting insert 1.2 arranged in the second receptacle 33 has a second orientation along the circumferential direction. Thereby, the first orientation is opposite to the second orientation—along the circumferential direction. The active main cutting edges 9.1, 9.2 are thereby arranged in an engagement position for machining a workpiece. In the embodiment shown here, the recess projections 5.1, 5.2 associated with the active main cutting edges 9.1, 9.2 point radially inwards in the direction of the central axis M, wherein the workpiece is arranged for machining by the cutting inserts 1.1, 1.2 in the region of the central axis M of the cutting insert holder 29.

Due to the different orientation of the rake faces 21.1, 21.2, a change in the direction of relative rotation between the workpiece and the cutting insert holder 29 is required between machining the workpiece with first the first cutting insert 1.1 and subsequently the second cutting insert 1.2. In this case, in particular, the workpiece can first be pre-machined with the first cutting insert 1.1 and then finish machined with the second cutting insert 1.2, wherein at the same time a burr formed during pre-machining is efficiently removed in the opposite direction to the previous cutting direction.

In particular, the cutting insert holder 29 is adapted to the workpiece to be machined in such a way that the first cutting insert 1.1 and the second cutting insert 1.2 can be fed towards the workpiece separately from each other and, in particular, one after the other in time—in the radial direction.

FIG. 6 shows a third representation of the cutting insert holder according to FIGS. 4 and 5. Here, on the one hand, the different orientation of the first rake face 21.1 and the second rake face 21.2 along the circumferential direction again becomes clear. On the other hand, it is represented here that the interface 37 can be configured as a VDI40 receptacle in a preferred configuration. However, in an equally preferred configuration, it can alternatively be configured in particular as a steep taper interface, Morse taper interface, HSK interface or in another suitable manner.

FIG. 7 shows a representation of a workpiece 39 for machining with the cutting insert 1 according to FIG. 1 and the cutting insert holder according to FIG. 4. The workpiece 39 is configured in particular as a toothed shaft. By means of the cutting insert 1, in particular the first cutting insert 1.1 and the second cutting insert 1.2, in particular by means of the cutting insert kit 27, in particular by means of the cutting insert holder 29, a recess 40, in particular a ring groove 41, in particular a Seegering groove, is preferably made in the workpiece 39. This results in a special way in the advantages described above, since a high stability is important for the cutting inserts 1.1, 1.2 especially due to the discontinuous cutting conditions prevailing in the area of the toothing, and burr formation takes place to a special degree.

FIG. 8 shows a schematic representation of an embodiment of a method for producing a recess 40, in particular a groove, in particular the ring groove 41 in the workpiece 39 according to FIG. 7.

During the method, the workpiece 39 is first pre-machined by grooving a preliminary recess comprising a first width with the first cutting insert 1.1, which comprises the first working width B1, which is also referred to as roughing. In this process, a relative rotation of the workpiece 39 to the first cutting insert 1.1, in particular to a tool 43, in particular to the cutting insert holder 29, is effected with a first direction of rotation. In particular, the workpiece 39 is preferably arranged for this purpose in the region of the central axis M of the cutting insert holder 29, wherein first the first cutting insert 1.1 is fed—in the radial direction—towards the workpiece 39.

Then the workpiece is finish-machined by extending the preliminary recess to a second width, which is greater than the first width, with the second cutting insert 1.2, which comprises the second working width B2, which is also referred to as finishing. This is possible because the second working width B2 is larger than the first working width B1. In this way, the recess 40, in particular the ring groove 41, is produced. During finishing, a relative rotation of the workpiece 39 with respect to the second cutting insert 1.2 is effected with a second direction of rotation which is opposite to the first direction of rotation of roughing. In particular, the relative rotation with the second sense of rotation is effected relative to the same tool 43, in particular to the cutting insert holder 29, relative to which the first relative rotation with the first sense of rotation was also effected. The resulting recess 40, in particular the ring groove 41, is deburred during finishing, i.e. finishing, by means of the second cutting insert 1.2, in particular with its deburring cutting edge 15.2. This is done particularly efficiently because the burr is cut off in the opposite direction to its direction of origin. For finish machining, the second cutting insert 1.2 is fed—in the radial direction—towards the workpiece 39.

The relative rotations are effected in particular between the cutting insert holder 29 and the workpiece 39 in each case. Since the cutting inserts 1.1, 1.2 are arranged with reversed orientation on the cutting insert holder 29, it is possible to reverse the direction of relative rotation between pre-machining with the first cutting insert 1.1 and finish machining with the second cutting insert 1.2, so that the burr can be cut off against its direction of origin. In particular, during pre-machining, only the first cutting insert 1.1 is engaged with the workpiece 39, while the second cutting insert 1.2 is not engaged with the workpiece 39. During finish machining, only the second cutting insert 1.2 is in engagement with the workpiece 39, while the first cutting insert 1.1 is not in engagement with the workpiece 39.

The recess 40, in particular the ring groove 41, is introduced into the workpiece 39 preferably in a hardened or quenched and tempered condition. The workpiece 39 preferably comprises a hardness of at least 36 HRC to at most 60 HRC.

Preferably, the process is carried out on a vertical lathe, on a horizontal lathe or on a machining center.

1. Cutting insert holder, having a central axis and at least one first receptacle for fastening a first cutting insert to the cutting insert holder, and having at least one second receptacle for fastening at least one second cutting insert to the cutting insert holder, wherein the first receptacle and the second receptacle are arranged offset from each other in the circumferential direction about the central axis, wherein the first receptacle and the second receptacle are configured and arranged in such a way that a first rake face associated with an active main cutting edge of a first cutting insert arranged in the first receptacle has a first orientation along the circumferential direction, wherein a second rake face associated with an active main cutting edge of a second cutting insert arranged in the second receptacle has a second orientation along the circumferential direction, wherein the first orientation is opposite to the second orientation when the first cutting insert and the second cutting insert are fixed to the cutting insert holder.

2. The cutting insert holder according to claim 1, wherein the cutting insert holder is adapted to a workpiece to be machined in such a way that a first cutting insert arranged on the at least one first receptacle and a second cutting insert arranged on the at least one second receptacle can be fed towards the workpiece separately from one another and, in particular, one after the other in time.

3. Cutting insert for recess machining, with
a base body, and
a recess protrusion projecting radially from the base body, wherein
the recess protrusion comprises a main cutting edge at a work end averted from the base body, and wherein
the recess protrusion comprises a deburring cutting edge at least on one side at a transition end facing the base body in the transition area to the base body.

4. The cutting insert according to claim 3, wherein the recess protrusion comprises a deburring cutting edge on both sides at its transition end.

5. The cutting insert according to claim 3, wherein the recess protrusion and the main cutting edge are configured and arranged relative to the base body in such a way that cutting forces are introduced tangentially into the base body during recess machining of a workpiece.

6. The cutting insert according to claim 3, wherein
the cutting insert comprises at least one material selected from a group consisting of cemented carbide and cubic crystalline boron nitride, and/or
the cutting insert is coated at least in the region of the recess protrusion.

7. The cutting insert according to claim 3, wherein at least one cutting edge stabilization geometry is associated with the main cutting edge, wherein the at least one cutting edge stabilization geometry is preferably selected from a group consisting of a rounding and a chamfer.

8. The cutting insert according to claim 3, wherein the cutting insert (1) is configured as an indexable cutting insert, wherein the cutting insert (1) comprises at least two recess projections (5) arranged offset from each other in a circumferential direction of the base body (3).

9. The cutting insert kit, comprising a first cutting insert according to claim 3, and comprising a second cutting insert, wherein the recess protrusion of the first cutting insert comprises a first working width, and wherein the recess protrusion of the second cutting insert comprises a second working width, and wherein the second working width is larger than the first working width.

10. Method for producing a recesses, in particular a groove, in particular a ring groove (41), in a workpiece, in particular a toothed shaft, having the following steps:
Pre-machining the workpiece by cutting a preliminary recess comprising a first width with a first cutting insert, in particular a first cutting insert according to claim 3, wherein a relative rotation of the workpiece to the first cutting insert is effected with a first direction of rotation;
Finish machining the workpiece by widening the preliminary recess to a second width, which is greater than the first width, and thus producing the recess, with a second cutting insert, in particular a second cutting insert, wherein a relative rotation of the workpiece to the second cutting insert is effected with a second direction of rotation, wherein
the second sense of rotation is opposite to the first sense of rotation, and wherein
the resulting recess is deburred during finish machining by means of the second cutting insert.

11. The method according to claim 10, wherein the first relative rotation between the workpiece and a tool comprising the first cutting insert and the second cutting insert, in particular a cutting insert holder, wherein the second relative rotation is effected between the workpiece and the same tool, wherein during pre-machining the first cutting insert is engaged with the workpiece, wherein during finish machining the second cutting insert is engaged with the workpiece.

12. The method according to claim 10, wherein for pre-machining the first cutting insert is fed towards the workpiece, wherein for finish machining the second cutting insert is fed towards the workpiece.

13. The method according to claim 10, wherein a toothed shaft is machined as the workpiece.

14. The method according to claim 10, wherein the recess is introduced into the workpiece in a hardened or quenched and tempered state of the workpiece, wherein the workpiece preferably comprises a hardness of at least 36 HRC to at most 60 HRC.

15. The method according to claim 10, wherein the method is carried out on a vertical lathe, on a horizontal lathe or on a machining center.
